(19) United States
(12) Patent Application Publication
(10) Pub. No.: US 2003/0110139 A1
(43) Pub. Date: Jun. 12, 2003

(54) Method of payment of shipping charges associated with product purchases made from a location remote to the product location

(76) Inventor: Lawrence Gaynor, West Bloomfield, MI (US)

Correspondence Address: KRISTEN NORLIE GOODMAN, DYKEMA GOSSETT PLLC, SUITE 300, 39577 WOODWARD AVENUE, BLOOMFIELD HILLS, MI, 48304-5086, US

(21) Appl. No.: 10/013,153

(22) Filed: Dec. 10, 2001

(51) Int. Cl. G06F 17/60; H04K 1/00; H04L 9/00

(52) U.S. Cl. 705/77

(57) ABSTRACT

A method of paying shipping charges for product purchases is provided, including the steps of a customer placing a first order for one or more products to be shipped to the customer, the customer purchasing additional products, at the seller's selling price, the total monetary amount of the additional product purchase being equal to 5% or greater of the shipping charges associated with the first order, and the seller paying the portion of the shipping charges equal to the total monetary amount of the additional product purchase. In another embodiment, the customer pays increased shipping charges in exchange for additional product at no charge to customer.

### BACKGROUND OF THE INVENTION

1. Technical Field

The present invention is related to the field of remote product purchases, and more specifically, is related the field of shipping charges resulting from a customer purchasing products from a location remote to the seller and the seller's products.

2. Description of the Related Art

Many purchases of goods are made when a customer is physically in the seller's place of business, the place of business also being the location of the seller's goods. Often, these places of business are referred to as brick-and-mortar stores. The customer can walk into a brick-and-mortar store, purchase the desired product (with any associated sale or use tax), and walk out of the store carrying the purchased product.

In this current age, the advent of mail-order catalogues, telephones, facsimile machines, and Internet web sites no longer requires the customer to be in the same location as the seller and the seller's goods to purchase the seller's goods. In fact, the seller does not need to be in the same location as his or her goods. Customers can purchase goods from a seller remotely, meaning, the customer does not take physical possession of the goods at the point of the sale. The seller offers his products for sale through the Internet, through catalogues, and other comparable marketing. The customer agrees to purchase the seller's products and the appropriate information is exchanged, such as customer name, address, credit card number, bank account number, etc.). The transaction has occurred (the customer's and the seller's minds have met and an agreement to sell products and buy the products has been made), but the goods have not moved from the seller's possession to the buyer's possession. If the customer, the seller and the goods to be purchased are not in the same location, the goods must be shipped to the customer. The goods are moved from the seller's possession to the buyer's possession, usually by a third party. The third party may move the goods via airplane, train, truck, boat or a combination thereof.

Shipping the products purchased by a remote customer incurs additional costs, commonly referred to as shipping charges. For example, the third party who physically moves the goods from one location to the other must be paid for his services. If the seller physically moves the goods (i.e., does not hire an outside vendor), the seller incurs the costs of paying labor to load and unload the products from the means of transportation, the cost of the means of transportation, the fuel to transport the goods, and other costs.

Under conventional methods, the buyer may pay the associated shipping charges with no incentive program available to the buyer to encourage a new purchase or a larger purchase. Other conventional methods involve incentive programs for customers, wherein sellers may offer to pay the shipping charges associated with the customer's purchase. While these methods may encourage customers to make a purchase, or make a larger purchase, these incentive programs can create a profit reduction or loss for the seller. Accordingly, there is a need for an improved method of providing incentive programs related to payment of shipping charges for products purchased remotely.

### SUMMARY OF THE INVENTION

It is an object of the present invention to provide a solution to one or more of the above problems. The present invention provides a method of the payment of shipping charges for products purchased by a customer at a location different from the location of the purchased products, which does not allow the customer to take physical possession of the goods at the time of the purchase.

In one aspect of the invention, a method in accordance with the present invention includes the step of a customer placing an initial order with a seller for one or more of the seller's products, the products to be shipped to the customer. Next, the shipping charges for the products are calculated by the seller. The method also includes the step of the customer then purchasing additional products, at the seller's selling price, from the seller that have a total monetary amount equal to five percent (5%) or more of the shipping charges associated with the customer's initial order. The additional products may be chosen by the customer or may be chosen by the customer from a group of products selected by the seller. The method also includes the step of the seller paying the portion the shipping charges associated with the initial order being equal to the total monetary amount of the additional product purchase. The portion the seller pays will not exceed the total shipping charges.

In other aspect of the present invention, a method of paying shipping charges is provided that includes the step of a customer placing an initial order with a seller for one or more of the seller's products; the products are to be shipped to the customer. Next, the seller calculates the shipping charges for the initial order. These shipping charges are of the amount the customer would pay if the customer does not avail herself of the present inventive method. The method also includes the step of the customer paying an increased amount for a portion, the portion an amount being 5% or greater, of the shipping charges associated with the initial order. The increased amount for the portion of the shipping charges is higher than the calculated amount for the portion of the total shipping charge associated with the initial order. Then, the customer receives additional products, at the seller's selling price, that may be chosen by the customer or may be chosen by the customer from a group of products selected by the seller, the total monetary amount for the total number of products selected being at least equal to the increased amount for the portion of the shipping charges associated with the initial order.

A method of paying shipping charges according to the present invention represents a significant improvement as compared with conventional methods. First, because the customer does not merely pay the shipping charges (the customer may pay for additional product instead of the shipping charges or the customer may pay the shipping charges and receive additional product), this encourages customers to purchase remotely and to purchase more products that they may otherwise would because of larger shipping charges. Second, the seller is able to offset the cost of the shipping charges because the customer is purchasing more product at the seller's selling price (for example, the retail price of a product, this price being higher than the cost of the product to the seller). Third, purchasing of products other than at the point of sale is encouraged generally, and this also reduces cost to the retail seller because not as much retail space (if any) is needed.

These and other advantages of this invention will become apparent to one skilled in the art from the following detailed description and the accompanying drawings illustrating features of this invention by way of example.

### DESCRIPTION OF THE DRAWINGS

FIG. 1 is a schematic of one embodiment of the invention.

FIG. 2 is a schematic of another embodiment of the invention.

### DETAILED DESCRIPTION OF THE ILLUSTRATED EMBODIMENTS

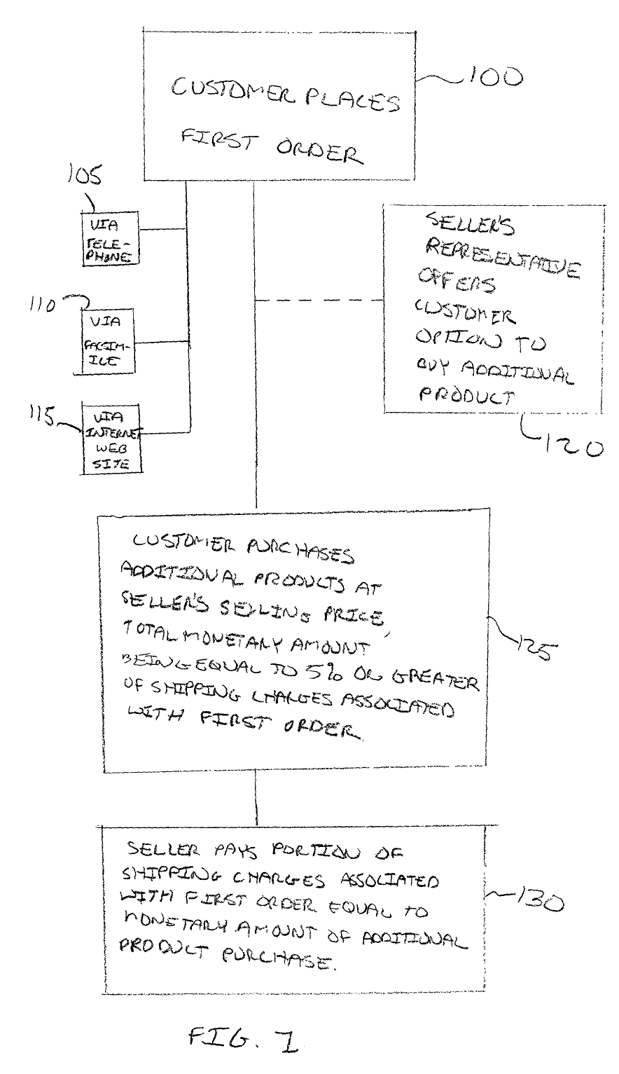

Referring now to the drawings wherein like reference numerals are used to identify identical components in the various embodiments, FIG. 1 is a schematic of one embodiment of the invention. Customer places a first order 100 with seller. Seller may be a retailer, a manufacturer, or a distributor of goods. Customer may place order via telephone 105 or via facsimile 110 or via seller's Internet web site 115. Seller's Internet web site may be a secure site. Once the customer places an order, the customer may be offered an option to participate in special program 120. This offer may be communicated through the seller's customer service representative on the telephone or it may be communicated through dialog boxes or menu driven screens on the seller's Internet web site. For example, once the customer indicates by clicking a “done” box or “continue” box that he will not be ordering any more products, a dialog box or new screen may appear asking the customer if he is interested in purchasing additional product in exchange for not having to pay associated shipping charges on his entire order. The offer may be limited by seller to those customers whose first order is less than a specified monetary amount or greater than a specified monetary amount, as specified by seller.

When the customer participates, the customer agrees to purchase additional products at the seller's selling price, the total monetary amount being at a specified amount set by seller 125. In particular, the total monetary amount of the additional product purchase is equal to 5% or greater of the shipping charges associated with the first order placed by the customer 100. The additional products the customer chooses may be chosen from a pre-selected group of products, the pre-selected group being selected by the seller. This pre-selected group may change often, such as monthly, or it may change infrequently, such as semi-annually. For example, the customer may choose from a selection of a certain brand of shampoos and a certain brand of manicure accessories. Or the customer may choose from one brand of nail polishes, but only certain colors of the one brand of nail polishes. In exchange for the customer purchasing a total monetary amount of additional products from the pre-selected group at the seller's selling price, the seller pays the portion of the shipping charges associated with the first order. The portion the seller pays is at least equal to the total monetary amount of the additional products purchase, not to exceed the amount of the total shipping charge associated with the first order 130.

As an example, a customer is located in Los Angeles, Calif. The customer telephones the seller, who is located in Detroit, Mich. The seller sells manicure products such as nail polishes, acrylic nails, nail files, nail buffers, and all associated accessories related to manicuring of nails. The seller may be a retailer (i.e., have a brick-and-mortar store) and sell to individual consumers. The goods may be located in the brick-and-mortar store or may be stored in another facility off-site, such as a warehouse. The seller may be a distributor of the manicure products, not have a brick-and-mortar store for “walk-in” customers and sell only to institutional purchasers (i.e., retailers, other distributors, or wholesalers) remotely. The products may be located in a location remote from the seller, again, such as a warehouse. The seller may be a wholesaler who does not have a retail store and sells products only to other wholesalers or to professional retailers remotely. The products may be located in a warehouse.

The customer places an order to purchase some of the seller's products and have the products shipped to the customer's location, Los Angeles. The customer orders for purchase $50.00 of products, in this specific example, ten bottles of Brand X fire engine red color nail polish, each bottle at the seller's selling price of $5.00. The seller's customer representative calculates the shipping charges incurred to ship the ten bottles of nail polish to the customer. In this example, the shipping charges would be $10.00. The seller's customer representative asks the customer if she would like to purchase an additional $13.00 in products from a pre-selected group of products. This $13.00 is 5% or greater, here, greater, than the shipping charges associated with the first order ($10.00). In this example, Brand X nail clippers and Brand Y acrylic nails are pre-selected products. The customer purchases Brand X nail clippers or Brand Y acrylic nails or a combination of the two, at the seller's selling price, the total monetary amount of the additional product purchase equaling at least $13.00. The seller then will pay the $10.00 total shipping charge on the first order and will not charge the customer for shipping the additional products. Since the total monetary amount of the additional product purchase exceeds the total shipping charges associated with the first order, the seller pays the total shipping charge of $10.00, but does not pay any more. When the customer purchases $13.00 of additional products she effectively receives $13.00 of additional product for a price of $3.00. The customer has purchased $13.00 of product, but the customer did not pay the $10.00 shipping charge associated with the initial order, resulting in a monetary savings for the customer on additional product.

The inventive method is advantageous to the customer as she receives a discount on products. It is advantageous to the seller because the seller's profit reduction is lessened. The seller has sold a total monetary amount of additional products, at the seller's selling price, of $13.00; the cost of the products to the seller is less than the seller's selling price. If seller merely paid for the $10.00 shipping charge, the seller has not his reduced product inventory. Additionally, while it may be that the $10.00 shipping charge associated with the first order is not the same cost to the seller, the seller may still not obtain as great a cost difference as exists between the seller's selling price of the products and the cost of the products to the seller.

If the total monetary amount of the additional product purchase is less than the total amount of shipping charges associated with the first order, the customer then pays the portion of the shipping charges above the total monetary amount of the additional product purchase. For example, if the shipping charges associated with an order are $20.00 and the customer purchases only $10.00 of additional products, the customer will be $10.00 in shipping charges for the first order.

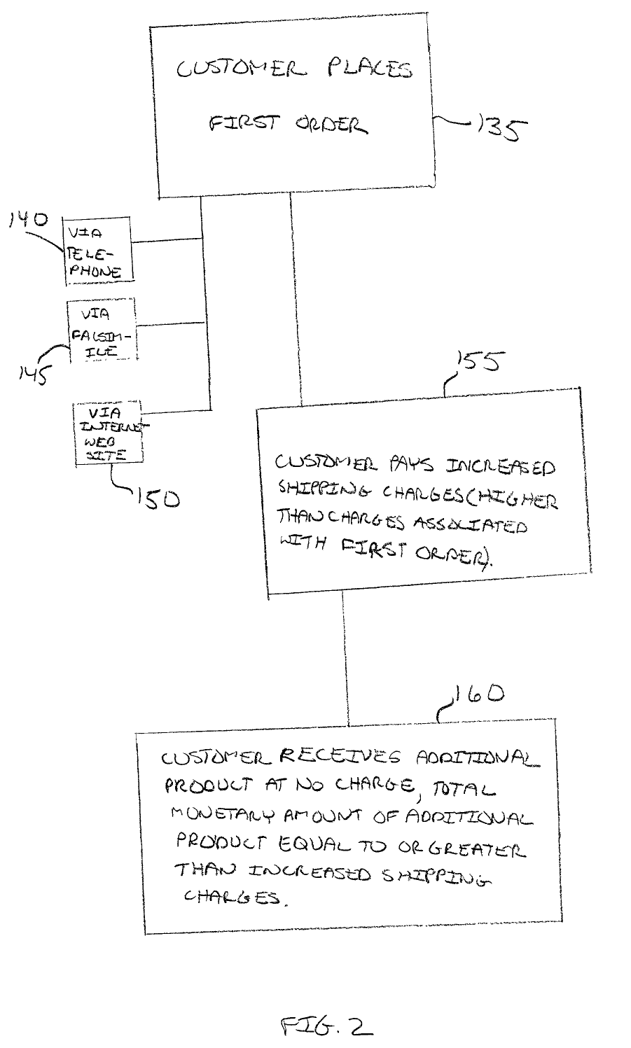

Referring now to FIG. 2, another embodiment of the invention is illustrated. A customer places a first order with seller 135. Again, seller may be a retailer, a manufacturer, or a distributor of goods. Again, customer may place order via telephone 140 or via facsimile 145 or via seller's Internet web site 150. There are shipping charges associated with the first order. The seller may offer the customer the option of paying higher shipping charges than the shipping charges associated with the first order and in turn, obtaining free additional product. This offer may be communicated and available only to customers whose first order is less than a specified monetary amount or greater than a specified monetary amount, the specified monetary amount determined by seller. If the customer agrees to pay a higher shipping charge than the shipping charges associated with first order 155, the customer receives additional product at no charge (either price of the product or associated shipping charge) 160. The total monetary value of the additional product customer receives, calculated at the seller's selling price for the additional product, may be equal to or greater than the higher shipping charge customer has agreed to pay. Again, the additional products the customer chooses may be chosen from a pre-selected group of products, the pre-selected group being selected by the seller. This pre-selected group may change often, such as monthly; the group may change infrequently, such as semi-annually. In another embodiment, the customer may not be restricted in choices of additional product.

As an example, again the customer is located in Los Angeles, Calif. The customer telephones the seller, who is located in Detroit, Mich. The seller sells manicure products such as nail polishes, acrylic nails, nail files, nail buffers, and all associated accessories related to manicuring of nails. As in the previous example above, the seller may be a retailer (i.e., have a brick-and-mortar store) and sell to individual consumers. The goods may be located in the brick-and-mortar store or may be stored in another facility off-site, such as a warehouse. The seller may be a distributor of the manicure products, not have a brick-and-mortar store for “walk-in” customers and sell only to institutional purchasers (i.e., retailers, other distributors, or wholesalers) remotely. The products may be located in a location remote from the seller, again, such as a warehouse. The seller may be a wholesaler who does not have a retail store and sells products only to other wholesalers or to professional retailers remotely. The products may be located in a warehouse.

The customer places an order to buy some of the seller's products, located in Detroit, and have the products shipped to the customer's location, Los Angeles. The customer orders $100.00 of products, in this specific example, fifty Brand A nail files, each nail file having a seller's selling price of $2.00. The seller's customer representative calculates the shipping charges incurred to ship the fifty nail files to the customer. In this example, the shipping charges would be $14.00. The customer then has the option to pay increased shipping charges totaling $18.00, $4.00 higher than the shipping charges associated with the first order. If the customer pays $18.00 in shipping charges, the customer receives additional products free of charge, the total monetary amount of the additional products, calculated at the seller's selling price for the additional product, totaling at least $18.00. The customer may not be restricted in choices of additional product or the additional products to be chosen may be limited to a pre-selected group of products, the group being selected by the seller. If the customer pays the increased shipping charge of $18.00, the customer has paid the shipping charges associated with the first order and receives $18.00 of additional product for a $4.00 charge.

The inventive method is advantageous to both the customer and the seller. The inventive method is advantageous to the customer as she receives a discount on seller's selling price for the additional products; the customer receives additional products with a seller's selling price higher than what the customer paid. It is advantageous to the seller because the seller's profit reduction is lessened. The seller has not paid the shipping charge. Further, the seller has sold a total monetary amount of $18.00 of additional products, at the seller's selling price; the cost of the products to the seller is less than the seller's selling price.

In another alternative embodiment not illustrated, the customer may be given the option to pay an increased monetary amount on a portion (for example, 5% or greater) of the shipping charges associated with the first order and receive additional product free, the total monetary amount of additional product being equal or greater to the increased monetary amount on the portion of the shipping charges. Customer then would pay the remaining portion of the non-increased shipping charges associated with the first order.

While the invention has been particularly shown and described with reference to the preferred embodiments thereof, it is well understood by those skilled in the art that various changes and modifications can be made in the invention without departing from the spirit and scope of the invention.

1. A method of paying shipping charges, comprising:
(A) customer placing a first order for one or more products to be shipped to said customer;
(B) customer purchasing additional products at seller's selling price, the total monetary amount of said additional product purchase being equal to 5% or greater of the total shipping charges associated with said first order;
(C) seller paying a portion of said total shipping charges associated with said first order, said portion being equal to said total monetary amount of said additional product purchase but not exceeding said total shipping charges associated with said first order.

2. The method of claim 1 wherein said placing of first order or said purchasing additional products is performed via telephone.

3. The method of claim 1 wherein said first order is placed through a seller's Internet web site.

4. The method of claim 1 wherein said first order is placed via facsimile.

5. The method of claim 1 wherein said additional product must be chosen from a pre-selected group of products, said pre-selected group determined by seller.

6. The method of claim 5 wherein said products chosen by seller in said pre-selected group change monthly.

7. The method of claim 5 wherein said pre-selected group changes semi-annually.

8. The method of claim 1 wherein said additional product may be chosen by buyer.

9. The method of claim 1 wherein the total monetary amount of said first order is at least equal to a monetary amount pre-specified by seller.

10. The method of claim 1 wherein the total monetary amount of said first order is less than a monetary amount pre-specified by seller.

11. A method of paying shipping costs, comprising:
(A) customer placing a first order for one or more products;
(B) seller offering to said customer an option to purchase additional products, at seller's selling price, the total monetary amount of said additional products purchase being equal an amount of 5% or greater of the total shipping charges associated with said first order;
(C) customer purchasing said additional products; and
(D) seller paying a portion of said total shipping charges associated with said first order, said portion being equal to said total monetary amount of said additional products purchase, but not exceeding said total shipping charge associated with said first order.

12. The method of claim 11 wherein said additional product must be chosen from a pre-selected group of products, said pre-selected group determined by seller.

13. The method of claim 12 wherein said pre-selected group changes monthly.

14. The method of claim 12 wherein said pre-selected group changes semi-annually.

15. The method of claim 11 wherein said additional product may be chosen by buyer.

16. The method of claim 11 wherein the total monetary amount of said first order is at least equal to a monetary amount pre-specified by seller.

17. The method of claim 11 wherein the total monetary amount of said first order is less than a monetary amount pre-specified by seller.

18. A method of paying shipping costs, comprising:
(A) customer placing a first order for one or more products;
(B) customer paying increased shipping charges, set by seller, on a portion of the total shipping charges associated with said first order, said portion being equal to 5% or greater of said total shipping charges associated with said first order;
(C) customer receiving additional products for no fee, the total monetary amount of said additional products, calculated at seller's selling price, being at least equal to said increased shipping charges.

19. The method of claim 18 wherein said additional product must be chosen from a pre-selected group of products, said pre-selected group determined by seller.

20. The method of claim 18 wherein said additional product may be chosen by purchaser.

21. The method of claim 18 wherein the total monetary amount of said first order is at least equal to a monetary amount pre-specified by seller.

22. The method of claim 18 wherein the total monetary amount of said first order is less than a monetary amount pre-specified by seller.
